(19) United States
(12) Patent Application Publication
(10) Pub. No.: US 2011/0279689 A1
(43) Pub. Date: Nov. 17, 2011

(54) Integrated Display Camera Using Oscillating Display Elements

(76) Inventor: Chad L. Maglaque, Seattle, WA (US)

(21) Appl. No.: 13/083,571

(22) Filed: Apr. 10, 2011

Related U.S. Application Data
(60) Provisional application No. 61/345,216, filed on May 17, 2010.

(51) Int. Cl. H04N 5/225; H04N 5/76

(52) U.S. Cl. 348/207.1; 348/333.01; 348/231.99; 348/E05.024

(57) ABSTRACT

Embodiments of the present invention provide a system for capturing photographic images with a camera integrated in an electronic display. The system includes: a display screen; a set of display elements coupled to a front side of the display screen; a set of masking elements coupled behind the set of display elements; and an image-capturing mechanism coupled to a backside of the display screen. The display elements are configured to cycle between an active state, in which the display elements are illuminated to display a display image on the display screen, and an inactive state, in which the display elements are darkened and at least partially transparent.

### CROSS REFERENCE TO RELATED APPLICATIONS

This application claims priority from the U.S. Provisional Patent Application Ser. No. 61/345,216 filed May 17, 2010, the disclosure of which is attached in Appendix A hereto and incorporated herein by reference.

### BACKGROUND

Embodiments of the present invention relate to techniques for capturing images. More specifically, embodiments of the present invention relate to a technique for capturing an image with a camera integrated in an electronic display.

Many personal computers, cell phones, personal digital assistants, and other electronic devices include built-in video cameras. These cameras enable users to take pictures, capture video, and participate in videoconferences.

One problem with traditional built-in cameras stems from the way that the cameras are mounted to (or within) the electronic device. Because the cameras are attached to a mounting point that is adjacent to the user's video display, the user cannot simultaneously look into the camera and view his or her display. Hence, it is difficult for the user to maintain eye contact during a videoconference with another person, because looking at the other person in the display means looking away from the camera. Users find themselves constantly looking back and forth between the display screen and the camera, which can be distracting and make the conversation seem awkward and unnatural. For the same reason, when attempting to take a self-portrait, a user cannot see what the photo will actually look like because glancing at the display means looking away from the camera. When looking at their display, users see an image of themselves looking away at an angle instead of looking directly into the camera. Thus, users that want a head-on portrait must look away from the display and into the camera, shooting blindly without any visual feedback from the display to guide them.

Some image-capturing mechanisms attempt solve this problem by cycling display elements between an active state, in which the display elements are illuminated to display a display image on the display screen, and an inactive state, in which the display elements are darkened and at least partially transparent. While the display elements are in the inactive state, an image-capturing mechanism is configured to capture a photographic image of objects in front of the display screen through the display screen and the display elements, for example in U.S. Pat. No. 2009/0009628. However these systems rely on complex timing between display components and image capture components.

Hence, what is needed is a camera in a computer system that does not suffer from the above-described problems. Embodiments of the integrated display camera allow embedding the camera within the actual display to achieve an accurate viewing angle, without degrading the image quality of the display—that is, the integrated display camera captures a mirror image of the subject, while remaining imperceptible to the subject viewing the display. Embodiments of the integrated display camera allow subjects to capture accurate images or videos of themselves, enabling a display to serve as a digital mirror. Embodiments of the integrated display camera allow subjects to capture stereoscopic images or videos of themselves. Embodiments of the integrated display camera allow subjects to capture images or videos of themselves with computer generated overlays that can be displayed in real-time.

### SUMMARY

Embodiments of the present invention provide a system for capturing photographic images with a camera integrated in an electronic display. The system includes: a display screen; a set of display elements coupled to a front side of the display screen; a set of masking elements coupled behind the set of display elements; and an image-capturing mechanism coupled to a backside of the display screen. The display elements and masking elements are configured to cycle between an active state, in which the display elements are illuminated to display a display image on the display screen and the masking elements prevent the display elements from displaying behind the masking elements, and an inactive state, in which the display elements are darkened and at least partially transparent and the masking elements are at least partial transparent. The image-capturing mechanism is configured to capture a photographic image of objects in front of the display screen through the display screen and through the display and masking elements while the display and masking elements are in the inactive state and configured to capture photographic images of objects in front of the display screen through the remainder of the display screen while the display and masking elements are in the active state.

In some embodiments, the image-capturing mechanism includes two or more separate image-capturing mechanisms coupled to the backside of the display screen at different locations. The separate image-capturing mechanisms are configured to capture photographic images of objects in front of corresponding portions of the display screen through the display screen and through the display and masking elements while the display and masking elements are in the inactive state and configured to capture photographic images of objects in front of corresponding portions of the display screen through the remainder of the display screen while the display and masking elements are in the active state. In some embodiments, the system includes an image-generation mechanism that is configured to generate a composite photographic image from the photographic images captured by the separate image-capturing mechanisms.

In some embodiments of the present invention, image-capturing mechanism 106 includes two or more separate image-capturing mechanisms which are coupled to display screen 104 in different locations. For example, the separate image-capturing mechanisms can be coupled to each of the corners of the backside of display screen 104 behind the display elements 303 and masking elements 304. For these embodiments, electronic device 100 generates a single image using the separate images captured by the parts of image-capturing mechanism 106. In these embodiments, software or hardware within electronic device 100 can stitch the separate images into a single image.

In some embodiments, the image-capturing mechanism includes a light-focusing mechanism which focuses received light onto a CMOS photosensitive array, an array of photodiodes, and/or an electronic image sensor.

In some embodiments, the display elements and masking elements are configured to cycle between the active state and the inactive state repeatedly.

In some embodiments, the image-capturing mechanism is configured to capture a photographic image during at least one or more consecutive active or inactive states.

In some embodiments, the display and masking elements are configured to substantially minimize the period of time in the inactive state to reduce the appearance of flicker of the display screen.

In some embodiments, the display elements are organic light-emitting diodes (OLEDs).

In some embodiments, the masking elements are organic light-emitting diodes (OLEDs).

In some embodiments, the display screen is coupled to a laptop computer, a desktop computer, a cellular phone, a personal digital assistant (PDA), an electronic organizer, a media player, a public or commercial display, an advertisement-generation mechanism, a security mechanism, an automated teller machine (ATM), an instrument panel or console, or another electronic device.

In some embodiments, the photographic image is a still image, a frame of video, or another type of image representation.

In some embodiments, a processor or hardware or software digital signal processor provide image correction for the photographic image.

### BRIEF DESCRIPTION OF THE FIGURES

Various embodiments of the present invention are described herein by way of example in conjunction with the following figures, wherein:

FIG. 1 illustrates a block diagram of an electronic device in accordance with embodiments of the present invention.

FIG. 2A presents a tablet computer where a set of display elements and masking elements are in an active state in accordance with embodiments of the present invention.

FIG. 2B presents a tablet computer where a set of display elements and masking elements are in an inactive state in accordance with embodiments of the present invention.

FIG. 3A illustrates magnified front and side views of an image-capturing mechanism coupled to a display screen where a set of display elements and masking elements are in an inactive state in accordance with embodiments of the present invention.

FIG. 3B illustrates magnified front view of a display screen where a set of display elements and masking elements are in an active state in accordance with embodiments of the present invention.

FIG. 4 presents a flowchart illustrating the process of capturing an image in accordance with embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The term “display” as used herein, includes without limitation any electronic visual display which performs as an output device for presentation of images transmitted electronically for visual reception, such as television sets, computer monitors, laptop displays, mobile device displays using active or passive display, electro-luminescence, inorganic or organic light emitting diodes, cathodoluminescence, LCD, photoluminescence, plasma, electrochromism, electrophoresis, etc.

The term “image sensor” as used herein, includes without limitation any device that converts an optical image to an electric signal such as charge-coupled devices (CCD), complementary metal-oxide-semiconductor (CMOS) active-pixel sensors, Bayer sensors, Foveon sensors, 3CCD sensors, thermal imaging sensors, gamma ray sensors, x-ray sensors, etc.

The term “interpolate”, as used herein, refers to a digital imaging technique that attempts to achieve a best approximation of one or more missing or degraded pixels' color and intensity based on the values at surrounding pixels, including without limitation adaptive and non-adaptive interpolation algorithms such as nearest neighbor, bilinear, bicubic, spline, sinc, lanczos, etc.

The term “chroma-keyed” or chroma-keying, as used herein, refers to a technique for color isolation and compositing two images or frames together in which a color (or a small color range) from one image is removed (or made transparent), revealing another image behind it. This technique is also referred to as color keying, colour-separation overlay, greenscreen, and bluescreen.

### Electronic Device

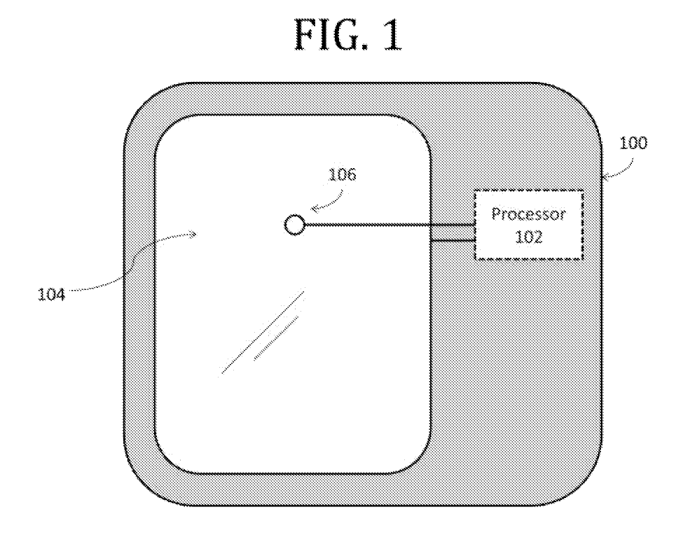

FIG. 1 presents a block diagram illustrating an electronic device 100 in accordance with embodiments of the present invention. Electronic device 100 includes processor 102, display screen 104, and image-capturing mechanism 106. In some embodiments of the present invention, electronic device 100 is a general-purpose electronic device that is used to capture still images and/or video. For example, electronic device could be used for video-conferencing and/or taking pictures.

Processor 102 is a central processing unit (CPU) that processes instructions. For example, processor 102 can be a microprocessor, a controller, an ASIC, or another type of computational engine. Display screen 104 is an electronic display screen that provides a user with a visual interface to electronic device 100. For example, display screen 104 can be a monitor, a display on a cell phone, a display on a PDA, a display on a camera, or another form of visual interface.

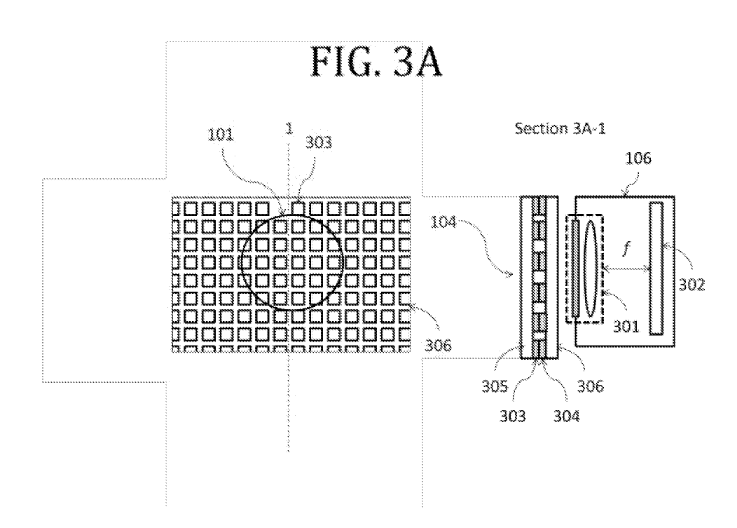

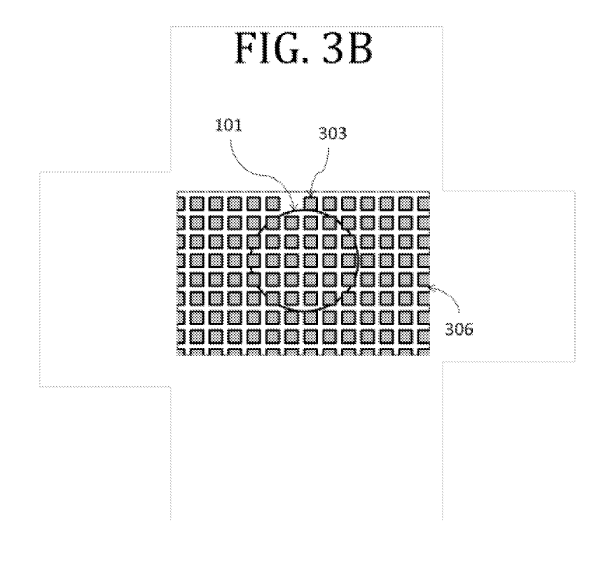

Display screen 104 is comprised of a number of display elements 303 (e.g., pixels) and masking elements 304 (see FIG. 3A) that cycle between an active state, wherein the display elements 303 illuminate to display the image on display screen 104 and the masking elements 304 prevent the display elements 303 from displaying behind the masking elements 304, and an inactive state, wherein the display elements 303 are darkened and at least partially transparent and the masking elements 304 are at least partial transparent.

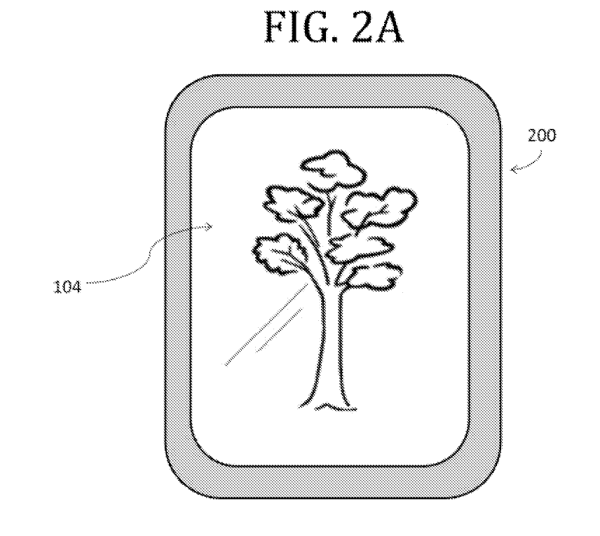

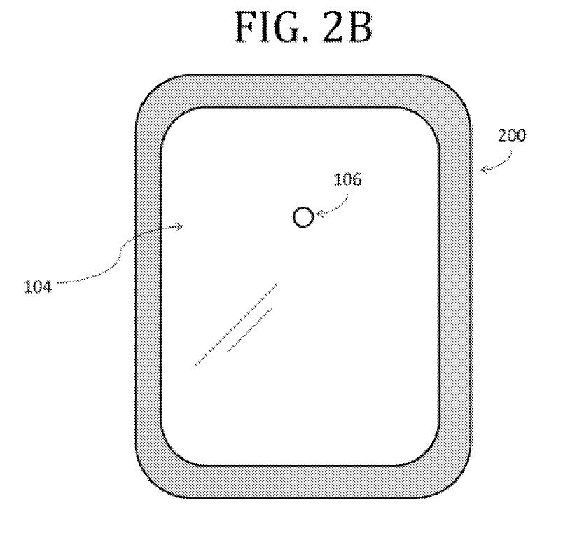

For example, FIG. 2A presents a tablet computer 200 where the display elements 303 and masking elements 304 are in the active state in accordance with embodiments of the present invention. In contrast, FIG. 2B presents a tablet computer 200 where the display elements 303 and masking elements 304 are in the inactive state in accordance with embodiments of the present invention.

In some embodiments of the present invention, the display elements 303 on display screen 104 are organic light-emitting diodes (OLEDs). An OLED belongs to a family of light-emitting diodes (LEDs) whose emissive electroluminescent layer is manufactured from organic compounds. An OLED typically includes a polymer substance that allows electroluminescent organic compounds to be deposited in rows and columns to form a matrix of pixels on a flat carrier. The resulting matrix of pixels can emit light of different colors. OLEDs are particularly suitable for display elements for electronic device 100, because OLEDs are capable of very high refresh rates (e.g., 1000 times faster than liquid crystal displays (LCDs)). Furthermore, OLEDs, when in the inactive state, can be 85% or more transparent.

Note that although we describe embodiments that use OLEDs as display elements 303, alternative embodiments use other types display elements that provide high refresh rates and at least partial transparency when in the inactive state and may equally provide partial transparency when in the active state.

In some embodiments, the masking elements 304 on the display screen 104 block any light from passing through the display screen when in the active state. In other embodiments, masking elements 304 can be of any size, shape, or configuration, blocking only the light from the display elements 303 and allowing some portion of the light from objects in front the display screen 104 to pass through the display screen 104 when in the active state.

In some embodiments, the masking elements 304 on the display screen 104 emit no light when in the active state. In other embodiments, the masking elements 304 can be set to a chroma-key color when in the active state to aid in color isolation later during image processing.

Masking elements 304 can use any type of masking element that provides at least partial transparency when in the inactive state.

Image-capturing mechanism 106 is a device that is used to capture photographic images. Image-capturing mechanism 106 includes one or more lenses, mirrors, prisms, filters, diffractors, shutters, apertures, and/or other elements that focus light and a photosensitive detector that converts light into electrical signals. For example, image-capturing mechanism 106 can include an aperture and a lens that focus light onto an electronic image sensor, a CMOS photosensitive array, and/or one or more photodiodes.

During operation, the light-focusing mechanism focuses received light onto the photosensitive detector. The photosensitive detector converts the received light into an electrical signal that is forwarded to processor 102. Processor 102 uses the electrical signal to create a digital image.

In some embodiments of the present invention, image-capturing mechanism 106 is coupled to display screen 104 behind the display elements 303 and masking elements 304. For example, image-capturing mechanism 106 can be coupled to the backside of the center of display screen 104, behind the display elements 303 located in that area (as seen in FIG. 2B).

In some embodiments of the present invention, image-capturing mechanism 106 includes two or more separate image-capturing mechanisms which are coupled to display screen 104 in different locations. For example, the separate image-capturing mechanisms can be coupled to each of the corners of the backside of display screen 104 behind the display elements 303 and masking elements 304. For these embodiments, electronic device 100 generates a single image using the separate images captured by the parts of image-capturing mechanism 106. In this embodiments, software or hardware within electronic device 100 can stitch the separate images into a single image.

In some embodiments, image-capturing mechanism 106 captures a photographic image throughout the duration of at least one or more consecutive active or inactive states (i.e., as the display elements 303 and masking elements 304 cycle from the active state to the inactive state one or more times). For example, display screen 104 may cycle from the inactive state to the active state 3 times in 50 ms as display screen 104 refreshes. During each inactive state, image-capturing mechanism 106 is exposed to light passing through the display screen 104, the display elements 303 and masking elements 304, and, depending on the size, shape and configuration of masking elements 304, during each active state, image-capturing mechanism 106 may be further exposed to some portion of the light passing through the display screen 104, to generate a photographic image. In some embodiments, processor 102, or alternatively a hardware or software digital signal processor, can provide image correction (such as image interpolation and color isolation) for the photographic image.

In some embodiments of the present invention, the cycle between the active state and the inactive state is set to be short enough to minimize the appearance of display “flickering.” For example, assuming that the frame rate is the rate at which some or all of the lines in display screen 104 are updated to provide consecutive images to the user, electronic device 100 may have frame rates of 60 or more frames per second.

In some embodiments of the present invention, electronic device 100 can be part of a security or information system, such as can be found in an airport, an automated teller machine (ATM), or a casino. For example, display screen 104 may display flight information, transaction information, or an online game, but may also serve as an image-capturing mechanism that facilitates facial recognition or monitoring to deter or prevent criminal activity. Alternatively, electronic device can be an advertising-display mechanism. For example, advertising signs may be configured to display advertisements of a particular type to different passers-by based on a computational estimation of the interests of the passers-by.

### Image-Capturing Mechanism

FIG. 3A presents an image-capturing mechanism 106 coupled to display screen 104 in accordance with embodiments of the present invention. (Note that the Elements in FIG. 3A are not to Scale.)

FIG. 3B illustrates magnified front view of a display screen where a set of display elements and masking elements are in an active state in accordance with embodiments of the present invention.

Image-capturing mechanism 106 includes focusing mechanism 101 and image sensor 102. Focusing mechanism 101 focuses light onto image sensor 102 which converts the focused light into an electrical signal that can be used to generate an image or video. Focusing mechanism 101 can include lenses, mirrors, prisms, filters, diffractors, shutters, apertures, and/or other elements that control the amount of light incident onto image sensor 102. Image sensor 102 can include a photosensitive CMOS array, an electronic image sensor, an array of photodiodes, and/or another mechanism that converts the focused light into an electrical signal.

Display screen 104 includes display elements 303 and masking elements 304, which are coupled between transparent layer 305 and transparent substrate 306. Transparent layer 305 and transparent substrate 306 provide a protective layer for display elements 303 and masking elements 304, as well as providing mechanical stability for display screen 104. Although we describe embodiments that use transparent layer 305 and transparent substrate 306, alternative embodiments use other configurations of display elements 303 and masking elements 304 and layers/substrates.

Display elements 303 and masking elements 304 cycle between an active state, wherein the display elements 303 illuminate to display an image on display screen 104 and the masking elements 304 prevent the display elements 303 from displaying behind the masking elements 304, and an inactive state, wherein display elements 303 are darkened and at least partially transparent and masking elements 304 are at least partially transparent. When display elements 303 and masking elements 304 are in the inactive state (and are therefore at least partially transparent), image-capturing mechanism 106 is exposed to light passing through the display screen 104, (i.e., through transparent layer 305, display elements 303 and masking elements 304, and transparent substrate 306). And depending on the size, shape and configuration of masking elements 304, during each active state, image-capturing mechanism 106 may be further exposed to some portion of the light passing through the display screen 104.

In some embodiments, image-capturing mechanism 106 includes a controller that controls the positions and/or orientations of lenses, mirrors, prisms, filters, diffractors, shutters, apertures, and/or other elements to focus or to compensate for various lighting and/or environmental conditions. For example, image-capturing mechanism 106 can increase a shutter speed in bright conditions. Alternatively, image-capturing mechanism 106 can move one or more lenses relative to one another to zoom in on a given object.

In some embodiments, software or additional hardware is used to manipulate the image generated from the electrical signal (or the electrical signal itself) from image sensor 302. For example, in some embodiments, digital (software) zoom facilitates focusing on one area of a captured image. Alternatively, an external hardware or software digital signal processor can provide visual noise reduction or electronic zoom, interpolation, color isolation, remove artifacts from the image, or can provide other forms of correction for the image.

Although we depict a space (i.e., an air gap) between display screen 104 and image-capturing mechanism 106, in alternative embodiments, image-capturing mechanism 106 is coupled directly to the backside of display screen 104.

### Image-Capturing Process

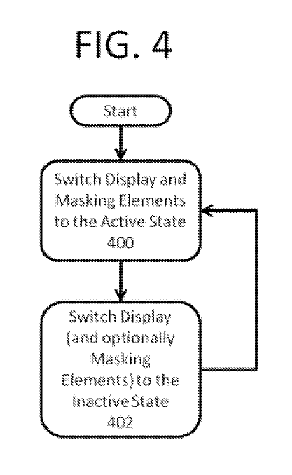

FIG. 4 presents a flowchart illustrating the process of capturing an image in accordance with embodiments of the present invention. The process starts when electronic device 100 switches a set of display elements 303 and masking elements 304 on display screen 104 to the active state (step 400). For example, when electronic device is first turned on, electronic device 100 can switch the display elements 303 and masking elements 304 to the active state to display a still image or a video on display screen 104.

Electronic device 100 then switches the display elements 303 and masking elements 304 to the inactive state (step 402). In some embodiments of the present invention, the display elements 303 and masking elements 304 can be switched to the inactive state specifically to expose image-capturing mechanism 106 is to light passing through the display screen 104. In other embodiments, the display elements 303 and masking elements 304 can be switched to the inactive state in order to refresh the image (i.e., to display the next consecutive image or portion of an image on display screen 104). In yet other embodiments, the display elements 303 can be switched to the inactive state in order to refresh the image (i.e., to display the next consecutive image or portion of an image on display screen 104) or to stop displaying images, while the masking elements 304 remain in the active state, the only requirement is that the masking elements 304 be in an active state when the display elements 303 are in an active state. Next electronic device 100 then returns to step 400 to switch the display elements 303 and the masking elements 304 to the active state.

In each of these embodiments, image-capturing mechanism 106 is exposed to light passing through the display screen 104 while the display elements 303 and masking elements 304 are in the inactive state, and depending on the size, shape and configuration of masking elements 304, during each active state, image-capturing mechanism 106 may be further exposed to some portion of the light passing through the display screen 104, allowing device 100 to capture an image as needed. In embodiments of the present invention, the display elements 303 and masking elements 304 are at least partially transparent in the inactive state, which exposes image-capturing mechanism 106 to light passing through the display elements 303 and masking elements 304 (and the display screen 104), and depending on the size, shape and configuration of masking elements 304, during the active state, image-capturing mechanism 106 may be further exposed to some portion of the light passing through the display screen 104.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus for capturing photographic images, comprising: a display screen; a set of display elements coupled to a front side of the display screen and a set of masking elements coupled behind the set of display elements, wherein the display elements and masking elements are configured to cycle between an active state, wherein the display elements are illuminated to display a display image on the display screen and the masking elements prevent the display elements from displaying behind the masking elements, and an inactive state, in which the display elements are darkened and at least partially transparent and the masking elements are at least partially transparent; and an image-capturing mechanism coupled to a backside of the display screen is configured to capture photographic images of objects in front of the display screen through the display screen and through the display and masking elements while the display and masking elements are in the inactive state and configured to capture photographic images of objects in front of the display screen through the remainder of the display screen while the display and masking elements are in the active state.

2. The apparatus of claim 1, further comprising: an image-generation mechanism; wherein the image-capturing mechanism includes two or more separate image-capturing mechanisms coupled to the backside of the display screen at different locations; wherein the separate image-capturing mechanisms are configured to capture photographic images of objects in front of corresponding portions of the display screen through the display screen; and wherein the image-generation mechanism is configured to generate a composite photographic image from the photographic images captured by the separate image-capturing mechanisms.

3. The apparatus of claim 1, wherein the image-capturing mechanism includes a light-focusing mechanism which focuses received light onto a CMOS photosensitive array, an array of photodiodes, and/or an electronic image sensor.

4. The apparatus of claim 3, wherein the display and masking elements are configured to cycle between the active state and the inactive state repeatedly.

5. The apparatus of claim 4, wherein the image-capturing mechanism is configured to capture a photographic image during at least one or more consecutive active or inactive states.

6. The apparatus of claim 4, wherein the display elements are configured to substantially minimize the period of time in the inactive state to reduce the appearance of flicker of the display screen.

7. The apparatus of claim 1, wherein the display elements are organic light-emitting diodes (OLEDs).

8. The apparatus of claim 1, wherein the masking elements are set to a chroma-key color when in the active state.

9. The apparatus of claim 1, wherein the display screen is coupled to a laptop computer, a desktop computer, a cellular phone, a personal digital assistant (PDA), an electronic organizer, a media player, a commercial or public display, an advertisement-generation mechanism, a security mechanism, an automated teller machine (ATM), an instrument console or control panel, or another electronic device.

10. The apparatus of claim 1, wherein the photographic image is a still image, a frame of video, or another type of image representation.

11. The apparatus of claim 1, wherein a hardware or software digital signal processor provides image correction for the photographic image.

12. A computing device for capturing photographic images, comprising: a processor; a memory coupled to the processor, wherein the memory stores data and instructions for the processor; a display screen coupled to the processor; a set of display elements coupled to a front side of the display screen and to the processor, and a set of masking elements coupled behind the set of display elements and to the processor, wherein the processor is configured to cycle the display elements and masking elements between an active state, wherein the display elements are illuminated to display the image on the display screen and the masking elements prevent the display elements from displaying behind the masking elements, and an inactive state, wherein the display elements are darkened and at least partially transparent and the masking elements are at least partially transparent; and an image-capturing mechanism coupled to a backside of the display screen and to the processor; wherein the processor is configured to use the image-capturing mechanism to capture a photographic image of objects in front of the display screen through the display screen and through the display and masking elements while the display and masking elements are in the inactive state and configured to capture photographic images of objects in front of the display screen through the remainder of the display screen while the display and masking elements are in the active state.

13. The computing device of claim 12, further comprising: an image-generation mechanism; wherein the image-capturing mechanism includes two or more separate image-capturing mechanisms coupled to the backside of the display screen at different locations; wherein the processor is configured to use each of the separate image-capturing mechanisms to capture a photographic image of objects in front of a corresponding portion of the display screen; and wherein the processor is configured to use the image-generation mechanism to generate a composite photographic image from the photographic images captured by the separate image-capturing mechanisms.

14. The computing device of claim 12, wherein the image-capturing mechanism includes a light-focusing mechanism which focuses received light onto a CMOS photosensitive array, an array of photodiodes, and/or an electronic image sensor.

15. The computing device of claim 14, wherein the display and masking elements are configured to cycle between the active state and the inactive state repeatedly.

16. The computing device of claim 15, wherein the image-capturing mechanism is configured to capture a photographic image during at least one or more consecutive active or inactive states.

17. The apparatus of claim 15, wherein the display elements are configured to substantially minimize the period of time in the inactive state to reduce the appearance of flicker of the display screen.

18. The computing device of claim 12, wherein the display elements are organic light-emitting diodes (OLEDs).

19. The apparatus of claim 12, wherein the masking elements are set to a chroma-key color when in the active state.

20. The computing device of claim 12, wherein the photographic image is a still image, a frame of video, or another type of image representation.
